(19) United States
(12) Patent Application Publication
(10) Pub. No.: US 2024/0282304 A1
(43) Pub. Date: Aug. 22, 2024

(54) APPARATUS AND METHOD FOR VOICE ACTIVATED TRACKING

(71) Applicants: Denis P. O'Hare, Platteville, CO (US); Carmelinda O'Hare, Platteville, CO (US)

(72) Inventors: Denis P. O'Hare, Platteville, CO (US); Carmelinda O'Hare, Platteville, CO (US)

(21) Appl. No.: 18/444,542

(22) Filed: Feb. 16, 2024

Related U.S. Application Data
(60) Provisional application No. 63/446,153, filed on Feb. 16, 2023.

(51) Int. Cl. G10L 15/22; G01S 19/01; G06F 3/16; G10L 15/26

(52) U.S. Cl. CPC G10L 15/22; G01S 19/01; G06F 3/167; G10L 15/26; G10L 2015/223

(57) ABSTRACT

A tracking device is coupled to an article. The tracking device includes a microphone for receiving a first voice command. The tracking device includes a processor in communication with the microphone. The processor translates the first voice command into a first group of text. The tracking device includes a memory for storing the first group of text. The tracking device includes one or more projectors for projecting a stimuli. The microphone receives a second voice command. The processor translates the second voice command into a second group of text. The processor compares the second group of text to the first group of text. If the second group of text matches the first group of text, the processor activates the one or more projectors to project a stimuli.

### FIELD

The present disclosure generally relates to wireless tracking systems, and more particularly to a device for voice activated tracking.

### BACKGROUND

It is common in personal and business life to lose items in many different areas, such as home, office, garages, hotels, airports, campgrounds, etc. and many more places. There has been a long felt need to provide effective and reliable assistance to people in locating misplaced articles such as a set of keys for home and/or business.

Some technologies have a two-piece system, including a transmitter, which is a remote-control piece, and a receiver that is attached to an item that may get lost. The drawback of these technologies is that the transmitter itself can and does get lost.

Therefore, a need exists to optimize device tracking in order to prevent loss and improve the location of lost articles.

### SUMMARY

A tracking device coupled to an article, the tracking device comprising a microphone for receiving a first voice command, a processor in communication with the microphone, the processor translating the first voice command into a first group of text, a memory for storing the first group of text, and one or more projectors for projecting a stimuli, wherein the microphone receives a second voice command, wherein the processor translates the second voice command into a second group of text, wherein the processor compares the second group of text to the first group of text, and wherein if the second group of text matches the first group of text the processor activates the one or more projectors to project a stimuli.

A method of tracking articles, the method comprising receiving a first voice command by a microphone, translating the first voice command into a first group of text by a processor in communication with the microphone, storing the first group of text in a memory, receiving a second voice command by the microphone, translating the second voice command into a second group of text by the processor, comparing the second group of text to the first group of text, and projecting a stimuli from one or more projectors when activated by the processor if the second group of text matches the first group of text.

A tracking device coupled to an article, the tracking device comprising a microphone for receiving a first voice command, a processor in communication with the microphone, the processor translating the first voice command into a first group of text, a memory for storing the first group of text, and a program button for activating the processor to receive the first voice command and store the first group of text into memory, one or more projectors for projecting a stimuli, wherein the microphone receives a second voice command, wherein the processor translates the second voice command into a second group of text, wherein the processor compares the second group of text to the first group of text, and wherein if the second group of text matches the first group of text the processor activates the one or more projectors to project a stimuli.

### BRIEF DESCRIPTION OF THE DRAWINGS

Various aspects and advantages will become apparent upon review of the following detailed description and upon reference to the drawings in which:

FIG. 1 illustrates a front view of a tracking device;

FIG. 2 illustrates an isometric view of a tracking device;

FIG. 3 illustrates a side view of a tracking device; and

FIG. 4 illustrates a circuit board of a tracking device.

### DETAILED DESCRIPTION

The following disclosure includes a method for locating articles and an apparatus for tracking, by utilizing The Swift Ecko, an article tracking device.

The Swift Ecko is an electronic component module; which annotates specific electronic components within The Swift Ecko device used to locate hidden or lost items. More particularly, it employs vocal commands and a GPS location chip in conjunction with a phone App specifically created for this electronic component module to locate lost items.

For the basic case that The Swift Ecko electronic components come in, is approximately the size of a quarter in diameter for the oval configuration and for the rectangular configuration of (TSE's) it is approximately 10 mm×10 mm×15 mm for easy attachment to glasses, and other smaller elongated objects. It comes with a hard exterior case. The Swift Ecko basic case is customized in black color and an oval or circular shape. The (TSE) cases may substantively be different in appearance so that many shapes and possible decorative cases such as a star, fish, unicorn, triangle, square, and/or small plastic animals can be “fitted” to hold The Swift Ecko electronic components module within them.

An electronic component module in a cost-effective manner that can make the process of finding a lost or hidden item easily and/or quickly. A lost item finding system called The Swift Ecko (TSE), that is comprised of a single electronic module. The two small flashing LEDs in the center of the cases of (TSE) on each side functions to selectively emit a bright visible light signal upon hearing the recorded word/name of the item (TSE) is attached to. The (TSE) cases can be customized in various shapes and colors and are available readily in regular shapes.

The Swift Ecko is capable of finding particular articles by using a simple and foolproof manner by just calling out its name. Such a locating device would be additionally useful and much more versatile if it could be used under almost any circumstance, which The Swift Ecko can. The Swift Ecko can never get lost because it is a stand-alone and an all-in-one device.

The Swift Ecko has a self-energizing pack as some smart watches have, for consistent energy, it keeps (TSE) operating for a longer and more robust life. It has the ability to be attached with ease to many articles and items that people lose in everyday life.

The objective of the invention is to create an electronic component module in a cost-effective manner that can make the process of finding a lost or hidden item easily and/or quickly. The Swift Ecko (TSE) device is a small, lightweight electronic device that attaches to everyday items that prevents them and the most important items from remaining lost. This device liberates a bright light and a loud chirping sound upon receiving the sound waves of from the person's voice that previously recorded the name within The Swift Ecko at the time of attaching it to the assigned product.

Furthermore, the addition of GPS within The Swift Ecko also helps trace the item via a mobile phone App. specifically created for (TSE) device. It will be useful for every common person and will be especially useful for disabled people that are deaf or blind. While operating the (TSE) device via the phone App. the item that is lost will be able to be found no matter the distance the person is from the lost item.

A lost item finding system called The Swift Ecko (TSE), that is comprised of a single electronic module. Simply press a small button on the (TSE) and record the name of an item that gets lost a lot like keys, a remote control, glasses, gloves, or many other items and then attach (TSE) to the item by a couple of different means. When the item is lost simply call out the name of the item that you're looking for and (TSE) will emit a loud chirping signal and a bright flashing light, enabling the user to locate the lost items.

The (TSE) cases may substantively be different in appearance so that many shapes and possible decorative cases such as a star, fish, unicorn, triangle, square, and/or small plastic animals can be “fitted” to hold The Swift Ecko electronic components module within them. Making it a nice addition to any piece of wardrobe, shoes, backpack, keys and many other items that might get lost.

The main objective of the invention (TSE) is to prepare a device that can make the process of finding the lost or hidden item easy and quick and at the same time it will look nice and be fun for kids of all ages. Furthermore, the addition of GPS also helps trace the item via mobile phone App. The Swift Ecko can also be in customized in some crazy shapes and different colors as desired.

The basic case of (TSE) is built in a manner that the diameter is approximately of the size of a quarter and 0.5 cm to 1 cm in thickness. The Embodiments of (TSE) device includes (a) one or two small bright light emitting diodes (LEDs); (b) a speaker; (c) a programming/recording button; (d) a tiny microphone.

The two small flashing LEDs in the center of the cases of (TSE) on each side functions to selectively emit a bright visible light signal upon hearing the recorded word/name of the item (TSE) is attached to. This is the visible signal this device emits. The other signal of (TSE), comes from two small speakers present on each side of the disc, which gives out a loud and high pitched “chirp” sound. By following the chirping sound the user will get close enough to the lost item to then be able to see the bright flashing light emitting from (TSE) and finding the item.

There is one programming button on the thin edge side of the disc case which are attached to a microphone. The function of the programming button is to record or program a word, or a short phrase, for example, “TV Remote”, “Car Keys”, “Dad's Truck Keys”, “Baby's Shoes” etc. in order for (TSE) to listen for the recorded word or short phrase and emit the signals accordingly. It has a voice recognition software within (TSE) to recognize the words clearly.

The device is preferably equipped with a speech reproduction unit that reproduces speech information stored in a memory. Furthermore, it is desirable for the device to be provided along with LED lights and a programming button, to send information signals to the user trying to find a lost item with the help of (TSE).

Thereafter, whenever the user who requires the lost item that is connected to (TSE), calls out the phrase recorded or programmed within (TSE) it sends out a loud chirping noise and the bright flashing LED. Again, with such light and sound signals one can easily figure out the location/placement of the equipment/item associated with the assigned (TSE). Further, once the device is found, it is essential to cancel the loud chirping sound and the bright flashing light. In order to stop/cancel the sound and the flashing lights, one must push/press the record button quickly only once.

Further, (TSE) has an interior self-energizing pack as is present in some smart watches. The self-energizing pack once charged has the ability to provide a consistent flow of energy to keep (TSE) constantly active and listening for the recorded word(s). It stays on energy savings mode, but keeps the device active while listening. There is a small protruding hole loop on the outside of the disc to attach it to the key chains, luggage, shoes, backpacks, gloves, necklaces, bracelets and other items to keep it attached to these items and more for finding them easily. The Swift Ecko device also has an option for double side tape. So that it can be attached to cell phones, remote controls, pocket calculators and any other object that may get misplaced or lost on a consistent basis.

The device will also have location tracker like GPS which can also be tracked by a mobile phone App. The (TSE) cases can be customized in various shapes and colors and are available readily in regular shapes such as triangle, rectangle, square, oval, heart, star, and a fish. The invention utilizes a very low duty cycle receiver-transmitter with an associated low power GPS chip, all operating within a reduced function cellphone, with speech encoding or decoding capability. The reduced cell-phone functionality needs to be able to transmit the simple data: GPS coordinates.

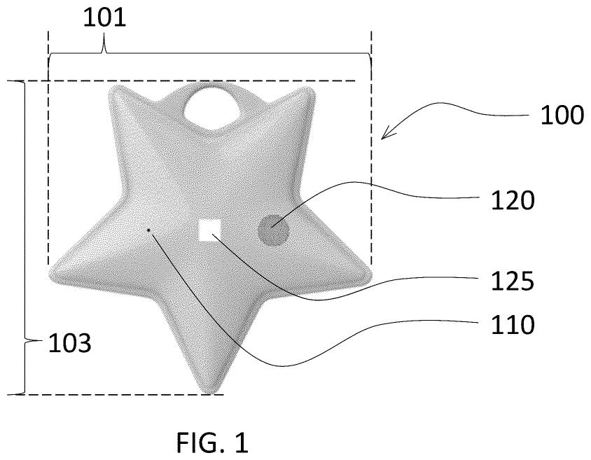

FIG. 1 illustrates a tracking device 100 for locating articles (e.g., articles of clothing). Tracking device 100 may have a microphone 110 and one or more projectors (e.g., one or more speakers 120 and/or one or more light emitters 125) to facilitate article tracking. Tracking device 100 may house electronic components (e.g., an electronic component module) that enable voice recognition and/or speech detection, including any of the above named components, a microprocessor, memory, and/or electrical circuitry connecting the various electronic components.

In its simplest form, voice recognition, or automatic speech recognition (ASR) may include recording a sound or a string of sounds of a voice, then listening for those sounds to reoccur, essentially matching the sound or string of sounds detected against the sound or string of sounds recorded (e.g., a speaker-dependent system). Nevertheless, this disclosure also contemplates more complex voice recognition algorithms, including, but not limited to, speech to text (STT) conversion, such that the sound or string of sounds need to be a perfect match to a specific speaker (e.g., a speaker-independent system). The voice recognition algorithm of the present invention may be text-dependent and/or text-independent. The voice recognition algorithm may use analog-to-digital (A/D) conversion. The voice recognition algorithm may use acoustic, vocal, and/or verbal modeling. The voice recognition algorithm may use detection, verification, and/or segmentation to listen to and/or identify words.

It may be desirable for tracking device 100 to respond only to a specific person (e.g., the person who performs the programming). Therefore, the voice recognition algorithm may utilize voice biometrics to enable identification of the person authorized to activate the system.

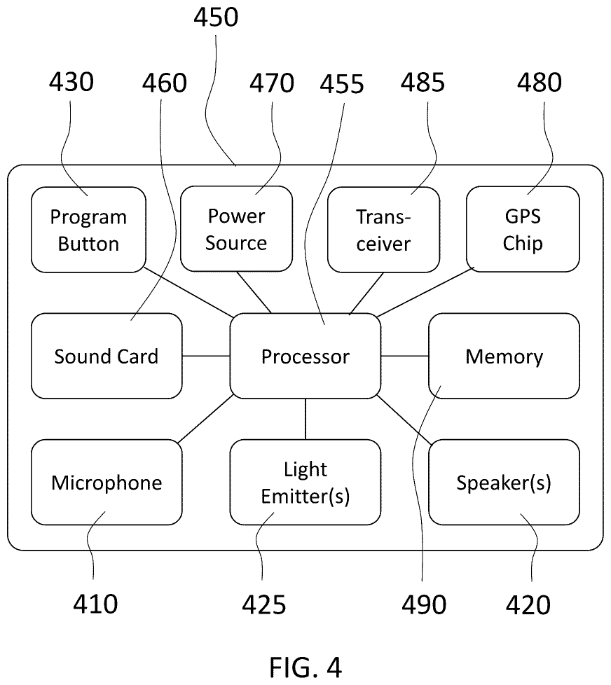

Voice recognition may require a sound card (e.g., a speech reproduction unit) and a microphone (e.g., microphone 110). Microphone 110 may listen to and/or capture the speech of the speaker. The sound card (e.g., sound card 460 of FIG. 4) may covert the speech (e.g., by an analog-to-digital conversion algorithm) into a digital form that can be interpreted by software and/or stored in a memory (e.g., memory 490 of FIG. 4).

The one or more speakers 120 may be configured on tracking device 100 to emit a chirping sound when tracking device 100 is activated (e.g., by voice command). Where at least two speakers 120 are configured on tracking device 100, each of the at least two speakers 120 may face and/or emit sound in different directions. Each of the at least two speakers 120 may face and/or emit sound in opposite directions. A first speaker 120 may be located on one side of tracking device 100, and a second speaker 120 may be located on an opposing side of tracking device 100. A first speaker 120 may be situated to emit sound outward from tracking device 100 in one direction, and a second speaker 120 may be situated to emit sound outward from tracking device 100 in a second direction. The second direction may be opposite the first direction.

The chirping sound emitted from the one or more speakers 120 may vary in pitch (e.g., within the audible spectrum, or from about 20 Hz to 20 kHz), nevertheless, unique applications may require sound to be emitted outside this spectrum. The chirping sound emitted from the one or more speakers 120 may vary in amplitude (e.g., from about 0 dBA to 140 dBA), nevertheless, unique applications may require sound to be emitted outside this range.

The one or more light emitters 125 (e.g., LEDs, or light emitting diodes) may be configured on tracking device 100 to emit a flash of light when tracking device 100 is activated (e.g., by voice command). Where at least two light emitters 125 are configured on tracking device 100, each of the at least two light emitters 125 may face and/or emit light in different directions. Each of the at least two light emitters 125 may face and/or emit light in opposite directions. A first light emitter 125 may be located on one side of tracking device 100, and a second light emitter 125 may be located on an opposing side of tracking device 100. A first light emitter 125 may be situated to emit light outward from tracking device 100 in one direction, and a second light emitter 125 may be situated to emit light outward from tracking device 100 in a second direction. The second direction may be opposite the first direction.

The one or more light emitters 125 (e.g., LDs, or laser diodes) may pulse, flash, or beat regularly or irregularly. The one or more light emitters 125 may pulse, flash, or beat relatively quickly (e.g., completing an “on” and an “off” condition, or a cycle of operation 10 or more times per second). The one or more light emitters 125 may pulse, flash, or beat relatively slowly (e.g., completing a cycle of operation more once every 3 seconds). The one or more light emitters 125 may pulse, flash, or beat anywhere in the range from 10 times per second to once every 3 seconds (e.g., twice per second).

The light emissions from the one or more light emitters 125 may vary in wavelength (e.g., within the visible light spectrum, or from about 700 nm to 400 nm), nevertheless, unique applications may require light to be emitted outside this spectrum. The light emissions from the one or more light emitters 125 may vary in amplitude (e.g., from about 0 lumens to 2000 lumens), nevertheless, unique applications may require light to be emitted outside this range.

The one or more speakers 120 and the one or more light emitters 125 may be oriented as described in this disclosure to increase the likelihood that the chirping and/or the flashes of light will be heard or seen (e.g., one side of tracking device 100 may be too close to an adjacent object on one side, such that chirping may be muffled and/or flashing light may be blocked from view). Projecting a stimuli (e.g., sound and/or light) in opposing directions increases the chance that tracking device 100 will be discovered quickly.

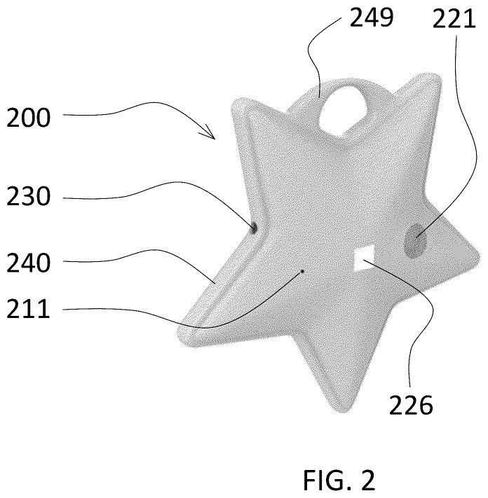

FIG. 2 illustrates a tracking device 200 for locating articles (e.g., electronic devices). Tracking device 100 may have one or more programming buttons 230 (e.g., a record button), a housing 240, and a loop 249 to facilitate article tracking. Programming button 230 may enable an orator to give voice commands to tracking device 200. The orator may press programming button 230 to activate a voice recognition algorithm.

The orator may press programming button 230 once to activate the voice recognition algorithm, then press the programming button 230 again to deactivate the voice recognition algorithm. The orator may press and hold the programming button 230 to activate the voice recognition algorithm, then release the programming button 230 to deactivate the voice recognition algorithm. The orator may press programming button 230 twice to activate the voice recognition algorithm, then press the programming button 230 again to deactivate the voice recognition algorithm. Other methods and combinations of pressing the programming button 230 are contemplated by this disclosure for activating and deactivating the voice recognition algorithm. Further, the voice recognition algorithm may be deactivated automatically after a period of time. The voice recognition algorithm may be deactivated three seconds after being activated. The voice recognition algorithm may be deactivated five seconds after being activated. The voice recognition algorithm may be deactivated seven seconds after being activated. The voice recognition algorithm may be deactivated ten or more seconds after being activated.

During the period of time when the voice recognition algorithm is activated, the orator may speak a voice command into a microphone (e.g., microphone 110 of FIG. 1) of tracking device 200. The microphone may receive analog audio sounds spoken by the orator. A sound card (e.g., sound card 460 of FIG. 4) may convert the audio sounds into digital audio (e.g., using analog-to-digital (A/D) conversion). The digital audio may be stored on a memory (e.g., memory 490 of FIG. 4) of tracking device 200. Tracking device 200 may have software which executes mathematical processing to remove background sounds and/or amplify the voice command. Tracking device 200 may have software which splits the digital sound into small sound segments and analyzes each segment to determine whether the sound segment is a consonant or a vowel, and/or which consonant or vowel the sound segment represents. Tracking device 200 may have software which runs an identification algorithm to determine what word and/or words were spoken in the voice command (e.g., representing a text string, or group of text). The identification algorithm may match the word and/or words spoken in the voice command with known words from a given language (e.g., the English language). The word and/or words matched to the voice command may be stored as text in the memory.

Tracking device 200 may have verification software for executing verification protocol to ensure the word and/or words stored in the memory correctly match the voice command given by the orator. Verification software may enable the word and/or words stored in the memory to be converted back into digital audio and/or transmitted as analog audio from an orator (e.g., speaker 120 of FIG. 1). The orator may indicate whether the word and/or words stored in the memory are correct by interacting with the programming button 230. The orator may press programming button 230 once to indicate the word and/or words stored in the memory are incorrect. The orator may press programming button 230 twice to indicate the word and/or words stored in the memory are correct. The orator may press and hold the programming button 230 for a period of time to indicate the word and/or words stored in the memory are correct. The period of time may be three seconds. The period of time may be five seconds. The period of time may be seven seconds. The period of time may be ten or more seconds. This disclosure contemplates any number of button configurations that enable the orator to indicate that the word and/or words stored in the memory are correct or incorrect.

Before or after programming is complete, tracking device 200 may be secured to an article (e.g., a bag or case). In the event that the article becomes lost, mislocated, or is otherwise missing, the orator may recite the voice command. The microphone may be in a listening mode at all times. The voice command may be converted and translated into a text command as described in this disclosure. The software of tracking device 200 may compare the text command given by the orator against the word and/or words stored in the memory. If the text command and the word and/or words stored in the memory are a match, software on tracking device 200 may cause one or more projectors (e.g., either or both of one or more speakers and one or more light emitters) to be activated (e.g., projecting a stimuli, such as audible sounds and/or visible light). The one or more projectors may be activated individually and/or simultaneously. If the text command and the word and/or words stored in the memory are not a match, software on tracking device 200 may cause microphone to go back into a listening mode, and the one or more projectors may not be activated.

Once the orator has located the tracking device 200 and/or the article on which it is affixed, the orator may deactivate the one or more projectors. The orator may press the programming button 230 once to deactivate the one or more projectors. This disclosure contemplates other button configurations for deactivating the one or more projectors. The one or more projectors may be deactivated individually and/or simultaneously.

Housing 240 may enclose the various components of the tracking device 200. A printed circuit board (PCB) may be affixed within housing 240. The PCB may facilitate the mechanical joinder and electrical interconnectivity of the microphone, the projectors (e.g., the one or more speakers and/or the one or more light emitters), the programming button 230 and any other electrical components (e.g., a memory, a processor, a sound card, a power source, a GPS chip, a transceiver, and electrical circuitry capable of facilitating communication between all of these components). Not all electrical components may be affixed to the PCB. All electrical components may be able to communicate through the transmission of electrical signals (e.g., through electrical circuits and/or wirelessly).

Housing 240 may have one or more apertures to enhance operability of tracking device 200. A microphone aperture 211 may be adjacent to a microphone to enhance receipt of analog audio to the microphone. A speaker aperture 221 may be adjacent to a speaker (e.g., speaker 120 of FIG. 1) to enhance projection of analog audio from the speaker. A light emitter aperture 226 may be adjacent to a light emitter (e.g., light emitter 125 of FIG. 1) to enhance projection of light away from tracking device 200.

Housing 240 may include a loop 249 secured to and/or constructed as part of housing 240. Loop 249 may enable securement of tracking device 200 to any article that may be lost or misplaced (e.g., key chains, luggage, necklaces, bracelets, backpacks, purses, sports bags, sports equipment, hats, and so forth) such as with a ring, clip, carabiner, or other means of attachment.

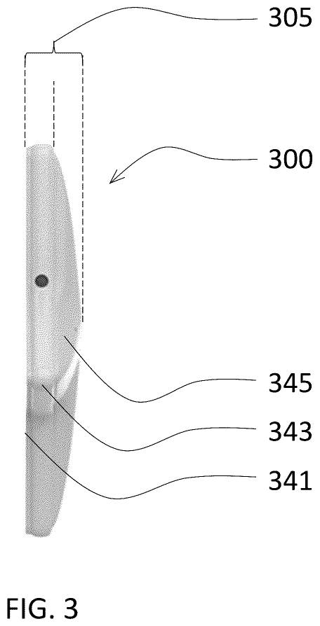

FIG. 3 illustrates a tracking device 300 for locating articles (e.g., equipment). Tracking device 300 may have a first side 341, a second side 345, and a perimeter portion 343 between the first side 341 and the second side 345 (e.g., defining an interior that houses the various electrical components of the tracking device 300).

First side 341 (e.g., a bottom side) may be flat. The flat geometry of first side 341 may enable first side 341 to be attached to an article having a corresponding flat surface (e.g., adhered to the article by double-sided tape, hook and loop fasteners, magnetic attachment, integral clip mechanism, or by other known means). Second side 345 (e.g., a top side) may be flat and/or contoured.

Tracking device 300 may be dimensioned to be small (e.g., between about the size of a nickel and about the size of a silver dollar). Tracking device may have a width dimension 101, a height dimension 103, and/or a thickness 305. The width dimension 101 may be between 5 millimeters and 100 millimeters (e.g., between 30 millimeters and 50 millimeters). The height dimension 103 may be between 5 millimeters and 100 millimeters (e.g., between 30 millimeters and 50 millimeters). The thickness 305 may be between 0.5 millimeters and 50 millimeters (e.g., between 5 millimeters and 10 millimeters). The size of tracking device 300 may make it easy to carry and/or well suited for attachment to any number of articles. The width dimension 101, height dimension 103, and/or thickness 305 may be similar or different in dimension.

FIG. 4 illustrates a printed circuit board 450 of a tracking device capable of performing the features and functions described in this disclosure. While the electronic components illustrated in FIG. 4 are exemplified as being coupled to a processor 455, this need not be the case in every instance and/or some of the remaining electronic components may be coupled to each other (e.g., sound card 460 may be directly coupled to microphone 410 to enable audio transmission and analog to digital conversion).

Processor 455 may contain the software presented in this disclosure and/or may facilitate performance of the algorithms presented in this disclosure. Processor 455 may be coupled, whether directly or indirectly, to a microphone 410, one or more speakers 420, one or more light emitters 425, a program button 430, a sound card 460, a power source 470, a GPS chip 480, a transceiver 485, and/or a memory 490.

Many of the above components have been discussed in this disclosure with respect to FIGS. 1 through 3. The GPS chip 480 may enable receipt of global positioning coordinates. Global positioning coordinates may be transmitted to transceiver 485. Transceiver 485 may transmit global positioning coordinates to an external receiver (e.g., to a remote computer, such as a cell phone), and may allow the location of the article to be tracked at great distances (e.g., beyond the tracking device's ability to detect audible voice commands from the orator).

Transceiver 485 may send signals (e.g., data) to and receive signals from the remote computer (e.g., a tablet). The data may include one or more of location information (such as GPS coordinates or coordinates provided through triangulation or other locating means), alert status information (such as whether the projectors are active, or have been active, or for how long they have been active), and text command information (such as the word and/or words stored in the memory). The word and/or words stored in the memory (e.g., a text string, or group of text) may be transmitted to transceiver 485 from the remote computer. The one or more speakers 420 and/or the one or more light emitters 425 may be activated and/or deactivated from the remote computer.

Power source 470 may provide electrical power to enable the operation of the electronic components coupled to printed circuit board 450. Power source 470 may be a lithium-ion or lithium-polymer battery. During a low battery condition of power source 470, a low battery alert may be relayed by transceiver 485 to the remote computer. During a low battery condition of power source 470, the one or more speakers 420 and/or the one or more light emitters 425 may be activated intermittently for a set period of time prior to power source 470 experiencing a complete loss of power. The one or more speakers 420 and/or the one or more light emitters 425 may be activated and deactivated in even increments (e.g., on for 5 seconds, off for 5 seconds), until deactivated by the orator and/or placed in a charging condition. The one or more speakers 420 and/or the one or more light emitters 425 may be activated and deactivated in uneven increments (e.g., on for 5 seconds, off for 55 seconds). This disclosure contemplates various increments of intermittent operation to indicate a low battery condition. Processor 455 may track power level information (e.g., a power level of power source 470, an estimated time remaining until power source 470 is depleted, and so forth). Transceiver 485 may transmit power level information to a remote computer. An orator may be able to designate how long before power source 470 is depleted the one or more projectors may be activated.

This disclosure also contemplates the deactivation of normal operation of certain components of the tracking device. A hearing impaired orator may not need the one or more speakers 420 to be activated at any time, and may rely exclusively on the one or more light emitters 425 to locate a lost or misplaced article. In this scenario, deactivating the one or more speakers 420 so that they don't operate during normal operation will enable the power source 470 to last much longer. Similarly, a seeing impaired orator may not need the one or more light emitters 425 to be activated and may rely exclusively on the one or more speakers 420. This disclosure contemplates the use of button combinations of the program button 430 to activate and/or deactivate certain portions of the tracking device. This disclosure also contemplates the use of the remote computer (e.g., via a software application) to control the various features and functions described in this disclosure.

While this disclosure has specifically referenced the use of one or more projectors, namely one or more speakers and/or one or more light emitters, this disclosure contemplates the use of various other projectors and/or projection means to alert the orator to the location of the lost article. A projector may include other devices that cause projection of a stimuli (e.g., such as transmission of an alert to a hearing aide of the orator, transmission of an alert to a home automation system, transmission of an alert to a smart device, transmission of an alert to a home security system, and so forth). A projector may include devices that cause projection of a smell. A projector may include devices that cause projection of vibration.

Other aspects will be apparent to those skilled in the art from consideration of the specification and practice disclosed herein. It is intended, therefore, that the specification and illustrated figures be considered as examples only.

What is claimed is:

1. A tracking device coupled to an article, the tracking device comprising:
a microphone for receiving a first voice command;
a processor in communication with the microphone, the processor translating the first voice command into a first group of text;
a memory for storing the first group of text; and
one or more projectors for projecting a stimuli, wherein the microphone receives a second voice command, wherein the processor translates the second voice command into a second group of text, wherein the processor compares the second group of text to the first group of text, and wherein if the second group of text matches the first group of text the processor activates the one or more projectors to project a stimuli.

2. The tracking device of claim 1, wherein the one or more projectors includes one or more speakers for projecting an audible sound.

3. The tracking device of claim 1, wherein the one or more projectors includes one or more light emitters for projecting visible light.

4. The tracking device of claim 3, wherein the one or more light emitters are light emitting diodes.

5. The tracking device of claim 1, further including a program button for activating the processor to receive the first voice command and store the first group of text into memory and/or for deactivating the stimuli projected by the one or more projectors.

6. The tracking device of claim 1, further including a GPS chip for providing global positioning coordinates to the processor; and further including a transceiver for transmitting the global positioning coordinates to a remote computer.

7. The tracking device of claim 1, further including a transceiver for transmitting data from the processor to, and to the processor from, a remote computer, wherein the data includes one or more of location information, alert status information, and text command information.

8. The tracking device of claim 1, further including a power source for supplying power.

9. The tracking device of claim 8, further including a transceiver for transmitting power level information about the power source to a remote computer.

10. A method of tracking articles, the method comprising:
receiving a first voice command by a microphone;
translating the first voice command into a first group of text by a processor in communication with the microphone;
storing the first group of text in a memory;
receiving a second voice command by the microphone;
translating the second voice command into a second group of text by the processor;
comparing the second group of text to the first group of text; and
projecting a stimuli from one or more projectors when activated by the processor if the second group of text matches the first group of text.

11. The method of claim 10, wherein the one or more projectors includes one or more speakers for projecting an audible sound.

12. The method of claim 10, wherein the one or more projectors includes one or more light emitters for projecting visible light.

13. The method of claim 12, wherein the one or more light emitters are light emitting diodes.

14. The method of claim 10, further including:
activating by a program button the processor to receive the first voice command and store the first group of text into memory; and
deactivating by a program button the stimuli projected by the one or more projectors.

15. The method of claim 10, further including:
providing by a GPS chip global positioning coordinates to the processor; and
transmitting by a transceiver the global positioning coordinates to a remote computer.

16. The method of claim 10, further including:
transmitting data from the processor to, and to the processor from, a remote computer, wherein the data includes one or more of location information, alert status information, and text command information.

17. The method of claim 10, further including:
supplying power from a power source.

18. The method of claim 17, further including:
Transmitting by a transceiver power level information about the power source to a remote computer.

19. A tracking device coupled to an article, the tracking device comprising:
a microphone for receiving a first voice command;
a processor in communication with the microphone, the processor translating the first voice command into a first group of text;
a memory for storing the first group of text;
a program button for activating the processor to receive the first voice command and store the first group of text into memory; and
one or more projectors for projecting a stimuli, wherein the microphone receives a second voice command, wherein the processor translates the second voice command into a second group of text, wherein the processor compares the second group of text to the first group of text, and wherein if the second group of text matches the first group of text the processor activates the one or more projectors to project a stimuli.

20. The tracking device of claim 19, further including a GPS chip for providing global positioning coordinates to the processor; and further including a transceiver for transmitting data from the processor to, and to the processor from, a remote computer, wherein the data includes one or more of location information, alert status information, and text command information.
